(19) United States
(12) Patent Application Publication
(10) Pub. No.: US 2011/0251871 A1
(43) Pub. Date: Oct. 13, 2011

(54) Customer Satisfaction Analytics System using On-Site Service Quality Evaluation

(76) Inventors: Robert Wilson Rogers, Toronto (CA); Milena Segatore, Toronto (CA)

(21) Appl. No.: 12/885,637

(22) Filed: Sep. 20, 2010

(30) Foreign Application Priority Data
Apr. 9, 2010 (CA) 2.699.871

(51) Int. Cl. G06Q 10/00

(52) U.S. Cl. 705/7.29

(57) ABSTRACT

This invention provides a service quality monitoring and improvement system. It is designed so that a number of different organizations or service providers can use the system simultaneously to obtain satisfaction data from customers and highlight areas for improvement. Customer satisfaction data is conducted at the site where the service or product is provided, to improve the response rate and data quality. For each user organization, the apparatus provides focused questions or information to improve service quality that are selected on the basis of feedback from their own customers. By using the system and making improvements in the areas identified, each user organization may improve the quality of the service it provides—leading to a wider customer base and improved profitability.

### RELATED APPLICATIONS

This application claims priority under Article 4 of the Paris Convention for the Protection of Industrial Property to a Canadian patent application having the same title and inventors, filed by 121QA Inc. on or about Apr. 9, 2010.

### TECHNICAL FIELD

This invention provides devices and technology for surveying and assessing customer satisfaction data for the purpose of improving the quality of service or products provided by an organization.

### BACKGROUND

Since 1985, there has been extensive research done on how service quality affects customer satisfaction, and how satisfaction in turn affects customer loyalty. The conclusion is that customer satisfaction develops when the quality of a service experience exceeds what customers expect to receive. Customer satisfaction leads to a greater affinity with the provider, future intent to repurchase and the predisposition to recommend the service to others. Service providers with high rates of customer satisfaction, retention and referral (known as customer loyalty) are more successful.

In practice, getting from satisfying customers to increased profitability is difficult, because service quality is variable. A satisfying experience one day can easily go wrong on another: changing customer expectations and internal breakdowns are common everyday occurrences in many service organizations.

Trying to understand what customers expect to receive and what dissatisfies them about a service experience can be hard. Customers are reluctant to give constructive criticism when they are dissatisfied and more likely to share a negative experience with friends. A frequently quoted statistic is that only 5% of customers who have a negative service experience tell the provider—while the remaining 95% share negative impressions with 8 or more friends. Negative word of mouth can have disastrous consequences. Knowing what satisfies customers and when things are not operating as they should is critical.

Large businesses like Starbucks, Disney and Four Seasons Hotels recognize that customer loyalty is earned by delivering good and consistent service. To achieve this, they operate on the principle that service experiences must be measured to be managed. Continuous surveying following customer service transactions has become common practice. Intelligence gathering has advanced from paper to the internet; enterprise-wide monitoring systems now generate a continuous stream of service metrics. The performance of different locations, services and staff members are routinely checked to find service deficiencies, and statistics drive improvement decisions. The entire process has come to be known as data or fact-based management.

Small businesses like dentists and other professionals, spas and salons do not typically manage by fact or customer satisfaction data. Service quality is learned by trial and error, and standardized systems, procedures and processes are less prevalent. The result is that both quality of service and customer satisfaction are variable. While entrepreneurs recognize the importance of listening to the voice of their customers to understand their expectations, and their proficiency in meeting them, many are reluctant to ask for feedback.

Frequently these businesses turn to an e-mail customer satisfaction survey for answers using do-it-yourself software and templates. However, the response rate is low, and the surveys are not designed to identify and fix weaknesses in a service product.

Prior art e-mail or internet based surveys do not generate representative, reliable and accurate response. A representative cross-section of customers and/or enough data over an extended period is rarely collected. Fluctuations in service quality and customer satisfaction are never identified. A low 10-20% survey response is common with e-mail surveys. Surveys that are not administered immediately following a service transaction rarely deliver a reliable statistical sample. Reaction to the physical, emotional or psychological aspects of the service experience is infrequently measured—what really satisfies or dissatisfies a customer is never confirmed.

Furthermore, previous survey systems do not identify a particular service weakness. Performance comparisons can only be made if accurate statistics, sufficient points of comparison and benchmarks are available. Technical language and complicated scoring often result in incomplete or inaccurate data. Answers are not always easy to translate into numbers or statistics against which comparisons can be made. Isolating a service deficiency without knowing how different locations, services or staff members are performing is impossible. Most organizations never field more than one survey at a time. Question standardization and internal and external benchmarks are rare. Assessing the severity of a problem without a point of comparison is generally not possible.

This kind of intelligence gathering is as likely to lead to more questions as it is to answers. In some cases, it can result in action being taken on a problem that does not exist or problems needing attention being completely overlooked.

Accordingly, there is a need for a small business alternative that can collect and compile customer satisfaction data using reliable analytics, revealing possible areas for improvement of service quality.

### SUMMARY OF THE INVENTION

This invention provides service quality monitoring and improvement systems, apparatus, and methods. It is designed so that a number of different organizations or service providers can use the system simultaneously to obtain satisfaction data from customers and highlight areas for improvement. Customer satisfaction data is conducted at the site where the service or product is provided, to improve the response rate and data quality. For each user organization, the apparatus provides focused questions or information to improve service quality, selected on the basis of feedback from their own customers. By using the system and making improvements in the areas identified, each user organization may improve the quality of the service it provides—leading to a wider customer base and improved profitability.

One embodiment of this invention is an apparatus or system for collecting, analyzing and reporting customer satisfaction data with respect to one or more commercial services provided by several different organizations that are being assessed by the apparatus (referred to here as “user organizations”). It typically comprises most or all of the following components:
An input means (such as a device or internet portal) for receiving scaled scores for customer loyalty metrics and/or a plurality of service quality metrics.
A survey database or storage unit set up to store scaled scores from customers who have purchased or used the commercial service provided by different user organizations.
A first analytical means or device for compiling the aforesaid scores amongst customers of each commercial service provided by each user organization.
A second analytical means or device for identifying potential errors in each organization or the way it provides each of its commercial service. The potential errors are identified using scores compiled from the organization's survey data by the first analytical means.
A solutions database or storage unit comprising questions or further information that can be used to address errors leading to suboptimal service quality, customer retention, or customer loyalty. The questions or further information may be selected for each service surveyed or assessed for each user organization in view of the potential errors that have been identified.

The apparatus of this invention will contain or provide one or more written reports for each user organization for the services it wishes to evaluate. The reports typically include the compiled scores, a report of the potential errors in the service provided, and questions or further information to assist the organization in improving or modifying the services they provide. The report may be in paper form, or set up for viewing in a computer monitor or over the internet.

The apparatus will collect survey data preferably using an input means that comprises a dedicated input terminal at the site of each user organization for immediate input of survey data by customers at the time of service.

The apparatus may further comprise a database of industry norms, benchmarks or targets for service quality to be used in the analysis and/or the written report for each user organization. The data being analyzed and compared may include scores obtained from different time periods, from different individuals at the organization, or from different divisions or locations in the organization.

In a prototype model of this invention, the customers are surveyed using about 25 different metrics. These include the following customer loyalty metrics: customer reported satisfaction, retention, and referral. Also included are service quality metrics for appearance (equipment, facilities, personnel, and/or materials); reliability (promises, problem solving, precision, timeliness, and/or accuracy); responsiveness (full disclosure, promptness, sensitivity, and/or accessibility); reassurance (trust, security, courtesy, and/or knowledge); and empathy (personalization, convenience, attentiveness, consideration, and/or understanding). Optionally, the service quality metrics may be modified by user organizations to deselect certain metrics or add others.

The apparatus of this invention may identify potential errors in each user organization or the way it provides the commercial service by comparing the compiled scores with industry norms, or with benchmarks or targets set by the organization. It may include customer comments linked to survey results of each customer.

Another embodiment of the invention is a method for collecting, analyzing and reporting customer satisfaction data using the apparatus already described. This typically entails receiving scaled scores for standardized questions answered by customers at a place where said service is provided; transmitting the scaled scores from where they are received to a database or central processing unit; compiling the scores; identifying potential errors in each user organization or the way it provides each commercial service; selecting questions or information to address such errors; and preparing written reports.

Another embodiment of the invention is a method for determining industry norms, comprising: receiving and transmitting scaled scores as already described; compiling scores periodically from at least 10 different customers who have purchased or used commercial services provided by a plurality of user organizations segregated according to industry or occupational classification; storing such scores and including them in written reports upon request. Another embodiment of the invention is a method for evaluating customer satisfaction data with respect to a particular commercial service provided to customers by a particular user organization; comprising: collecting customer satisfaction data; selecting industry norms according to the industry or occupational classification of the particular commercial service; and preparing a written report.

A further embodiment of the invention is a method for improving a commercial service provided by an organization. This involves evaluating the commercial service as already stated, and then addressing any errors in the organization or the way it provides the commercial service that are highlighted in the compiled results of the survey.

Other embodiments of the invention will be apparent from the description that follows.

### DRAWINGS

FIG. 1 is a flowchart showing system architecture for a working model of this invention, designed for access by user organizations under the trademark 121QA.

FIG. 2 is an image of a survey question presented to the customer for evaluation of service quality. This example uses a seven-point Likert scale, in which customers specify their level of agreement to the statement shown above.

FIG. 3 shows a scorecard report, which provides the user (a manager or consultant for the organization) with compiled data as bar graphs. The control panel with links to further data, information, and functions of the system is shown to the left. Further aspects of the information displayed are explained in the boxed text.

FIG. 4 shows a panel in which the user may choose different time periods for analysis and display, different employees of the organization, and different comparators.

FIG. 5 shows a panel in which the user may input or revise the service quality targets they wish to achieve.

FIGS. 6(A) and 6(B) show panels in which the user is directed towards areas that may need corrective action. The system then provides links for self-assessment questions or further information relating to fact finding, organization, management, and communication that enable the user to consider and improve the quality of service provided to future customers.

### DETAILED DESCRIPTION

The service quality monitoring and improvement system described in this disclosure may be used for collecting, analyzing and reporting customer satisfaction data with respect to one or more commercial services provided by several different organizations that are being assessed by the apparatus (referred to as subscriber or user organizations). The system provides a survey, database and diagnostics instrument all-in-one. It makes it practical for various user organizations (such as professionals, partnerships, small businesses and not-for-profit entities) to do any or all of the following:
Collect customer feedback at the point of transaction on a continuous basis;
Compare their service experience against industry norms and business targets;
Identify areas of weakness and strength in their service product; and,
Adopt a diagnostic process that leads to continuous service improvement.

The system creates a business database with analytic capabilities comparable to large enterprise solutions. It simplifies the collecting and analyzing of customer service feedback and helps each user organization translate customer response into service improvement. It can be used advantageously by each subscribing organization without previous knowledge of customer research, statistics, or survey design.

The invention differs from one-off in-house systems or separately implemented survey modules in that it is designed so that different subscriber organizations can use it simultaneously. Furthermore, the invention addresses the problems of prior art survey systems by a variety of new and inventive features. These include:
A database-driven scorecard that presents statistical results generated by the survey, i.e. mean, mode and range scores. It also offers the functionality of comparative assessment against industry norms, business targets set by the subscriber and between locations, services and personnel.
A diagnostics package that identifies service quality weaknesses triggered by the comparative dimensions built into the database. Service quality weaknesses are divided into four categories. Each category comprises time tested questions that help the user precisely define potential errors and develop solutions.

The customer satisfaction survey system of this invention typically includes the following components:

### 1. Input Portal

The system or apparatus of this invention has a means whereby the customers of each user organization may input the results of the survey questions. Although the system can be set up to collect survey data after the consumer has left the office, typical embodiments have a dedicated terminal at the site of service delivery of each user organization. This improves response rate and data quality.

### 2. Survey Questionnaire

The service quality monitoring and improvement system of this invention uses recognized metrics of customer loyalty and service quality. It is designed to be administered at the end of any service transaction in any location. Different locations, services and staff members can be surveyed for each user organization on a concurrent basis.

The survey comprises a suitable number of time tested survey questions. A customer can typically respond to the survey in about three minutes on any suitable device, including a web-enabled device or hand-held smart phone. Each questionnaire may have its own unique web address with a GUID link that can be opened by any http browser.

Each organization using the apparatus or system of this invention initializes each survey link when they register. This is done by identifying the subject to be surveyed. In order to do this the user must register their business and identify their North American Industry Classification (NAICS code) from the list provided. The user then selects their Standard Occupational Classifications (SOC code), and inputs the name of the business location, service or staff member to be surveyed. The name and occupational description appear as the subject heading of the questionnaire. This process is repeated for each survey link. Once registration is completed internal identification codes are generated for the business, their survey links and their respective NAICS and SOC classifications.

The subject of a survey link can be changed at any time following registration by re-initializing the questionnaire. Additional survey links can also be added and links can be turned on and off depending on the desired frequency of survey administration. The date, time and subject of any change in survey link disposition are recorded and links remain assigned to the user as long as they are registered.

In embodiments of this invention intended for general use, customer loyalty and service quality is surveyed using established North American standards or metrics. Typically this includes at least 15 or 20, and no more than 30 or 40 (ideally about 25) easy-to-understand questions that explore the customer's service experience—their impressions and their perceptions of the quality of the product. Some of the questions deal with customer loyalty: i.e., customer satisfaction and their future intent to repurchase and refer. Other questions explore perceptions of the appearance, (equipment, facilities, personnel, and/or materials); reliability (promises, problem solving, precision, timeliness, and/or accuracy); responsiveness (full disclosure, promptness, sensitivity, and/or accessibility); reassurance (trust, security, courtesy, and/or knowledge); and empathy (personalization, convenience, attentiveness, consideration, and/or understanding).

### 3. Survey Results Database

The service quality monitoring and improvement system of this invention typically comprises various databases for storing customer survey data, comments, compilations, and questions or information for solving potential errors in a commercial service provided by an organization. These databases may be on separate storage units in the apparatus, they may be electronically structured storage matrixes on the same storage unit, or a combination of both of these.

This invention typically warehouses survey scores as raw data into the survey database. The data are partitioned between different surveys run for the same user organization and between different organizations. They are used by the apparatus to compile results and generate statistics for display on the scorecard. Survey responses may be transferred in real time to the database, allowing statistics to be calculated automatically.

### 3. Industry Norms Database

Besides compiling data for the business aspect and customer base selected by the user organization to be surveyed, the apparatus may also compile data across the entirety of the survey database, or across various industry sectors within the database of particular interest. By way of illustration, data for each industry or occupational classification, or each geographical location can be compiled separately using survey data from all the surveys conducted for all organizations meeting the same criteria. The data can be averaged between organizations, optionally weighted for the number of customers responding to the survey questions for each organization.

This establishes normative data for each classification that can then be stored in the norms database. Industry norms can then be provided as a benchmark value for the results of a particular survey that is called up by a user organization on the respective scorecard.

### 4. Customer Comments Database

Optionally, the survey system of this invention can give the user a chance to input written text comments, in addition to their answers to the survey questions. The written comments are stored in the comments database, and are linked to the answers provided to the survey questions by the author. This way, when the user organization logs on to the system to view survey results on the scorecard, they can review the written comments in the context of that customer's answers to each aspect of the survey. When the survey is conducted at the site where the service is provided, the customer can be given the option of providing written comments later. This improves response rates to the survey as a whole, and the written feedback portion.

### 5. Scorecard

The service quality monitoring and improvement system of this invention provides a written report or scorecard for each service surveyed for each user organization. The compiled data for each metric may be compared with one or more comparative benchmarks.

Data from the survey database are compiled and statistically analyzed amongst customers of each commercial service provided by each user organization. The compiled data are then used for identifying potential errors in each organization or the way it provides each of its commercial service. This can be done by identifying particularly low scoring metrics, or by comparing the scores with some type of benchmark for each metric. These analytical steps may be done by any suitable means, such as a programmed or dedicated computational component of the apparatus or equivalents thereof.

The scorecard can compare results of the survey with other individuals, divisions, geographical locations, or time periods that have been surveyed separately. The scorecard can also compare results against comparative benchmarks. These can be targets for each question set by the user, either when they register, or at a subsequent time. A business target is set by selecting a rating for each survey question for the business or business sector that the user has selected for analysis. Alternatively or in addition, the scores can be compared with industry norms retrieved from the norms database for similar businesses or having the same NAICS classification.

Where the perceived quality of service falls below a business target or industry norm red highlights automatically identify areas of weakness on the scorecard. Highlights can be investigated by investigating the performance of different locations, services or staff members over varying periods of time. Verbatim comments can also be searched for clues to a problem.

### 6. Solutions Database

The apparatus of this invention also comprises an archive of diagnostic questions or information to provide focus for improving service quality. Particular diagnostic questions or information may be selected by the system in view of potential errors identified for each service surveyed for each user organization. Alternatively, the apparatus may be set up so that each metric reported on the scorecard is linked to the diagnostic questions or information that are appropriate for the metric.

Once a service weakness is identified, diagnostic questions appear to help guide the search for the root cause and the best fix for the problem. When procedures, processes or people are changed, results can be tracked to gauge incremental improvements in the service product.

In a working prototype of the invention described below, the diagnostic questions are standardized and selected based on compiled survey data. Alternatively or in addition, diagnostics can be customized so as to be triggered by deficiencies, connected directly to the problem (and survey question) and formatted as questions so as to cause the user organization to enter into a process of self-examination and root-cause analysis. This type of self-administered smart system moves surveying from strictly identifying problems to finding second stage remedial solutions tailored to the needs and peculiarities of the user organization. In this sense, the invention automates and bypasses customer research and business or practice management consulting. Several extensions are possible:
The diagnostic questions can be specialized by industry or user organization;
They can be changed, increased in number and/or modified as a body of knowledge increases; or
An entirely new set of diagnostic questions can be created for a new survey on a new topic.

### 7. Implementation

The system or apparatus of this invention can be set up so that different organizations can subscribe and become users independent of operator participation. The prototype example described below has an automatic sign-up or subscription portal, through which user organizations can identify themselves, select surveys to run, and arrange for payment. User organizations log back on at a later time to see the scorecard for each survey.

It has been discovered that by having the survey available for customers to use at the site where the service is provided, the user organization typically will not need to provide incentives to promote participation. By having just a few customers complete the survey every day, the organization will obtain considerably more data than surveys that customers are expected to respond to after-the-fact.

Nevertheless, if desired the system and apparatus of this invention can be implemented in a way that provides incentives where user organizations consider them desirable. When a user organization first subscribes to the system, it can be given the option of providing each responding customer with a benefit—for example, a discount coupon for use at the organization or elsewhere, a free item, or commitment to make a contribution to a charity. The customer would receive the benefit upon completing most or all of the survey questions, for providing written comments, or both.

The system or apparatus of this invention may be set up to have as a central processing unit a computer configured to receive customer data transmitted to it over the internet or by other reliable means from the customer-accessible input terminals. The central processing unit maintains the various databases needed for information storage. It performs database management, compilation, analysis, and report writing functions in accordance with this invention as instructed by programmed computer executable software code stored in memory or in a computer-readable medium. In some embodiments the central processing unit is a general purpose computer and peripheral devices specifically programmed to carry out the steps of the functions described here. In other embodiments, the central processing unit is a dedicated or specialized unit set up to optimize the manner in which this invention is deployed and utilized. The apparatus as a whole can be considered to include input terminals remote from the central processing unit, optionally located at each user organization's site of service. The apparatus can also be considered to include interactive report terminals by which the user organizations retrieve and consider survey results and analytical questions provided as a result of the analysis. The user organizations may then implement changes to their organizations as indicated or suggested by the information retrieved from the solutions database, and/or perform follow-up customer surveys.

### ADVANTAGES

The customer satisfaction survey apparatus of this invention is superior to previously available systems and methodologies—such as surveys implemented by individual service organizations according to their own criteria.
The survey is ready for immediate implementation. Questions can be standardized to be suitable for a wide range of service industries. As soon as a user organization signs on as a subscriber, the apparatus can immediately be made accessible to accumulate survey results and archive them in the survey database
The survey can be answered by consumers right at the site of delivery. The customer input portal can be set up as a dedicated access computer near the reception or checkout area the customer passes through on leaving. Questions in the working example can be answered in about three minutes, which makes it reasonably convenient for customers to complete before they leave the premises. This provides a considerably improved response rate and obtains responses from a broader spectrum of incomes and customer groupings.
Survey scores and comments are automatically transferred and archived in the survey database. Results can be called up and viewed on the user organization's scorecard in real time.
Since the same questions are used by different organizations, the data can be used to calculate industry norms. This gives user organizations true insight into how their service quality compares with competing organizations, rather than being inferred from arbitrary criteria.
By using a centralized and standardized data collection and analysis unit, surveys can be run and compiled by small business organizations in a much more cost efficient way. The working example shown below can be run at a profit by charging user organizations $80 per month for 3 unlimited surveys. Compare this with standard customer surveys, which typically cost $500 to $5,000 per survey wave, plus $5 to $50 per tabulated response.

### EXAMPLE

By way of illustration, a working prototype of this invention has been created, for access by user organizations under the trademark 121QA. The working prototype uses 2.0 web components and recognized standards. Organizations may subscribe to the system through the internet. Once registration is complete, the organization may access the various databases and begin surveying their customers. The quality assessment ensues from scoring the 25 metrics referred to earlier.

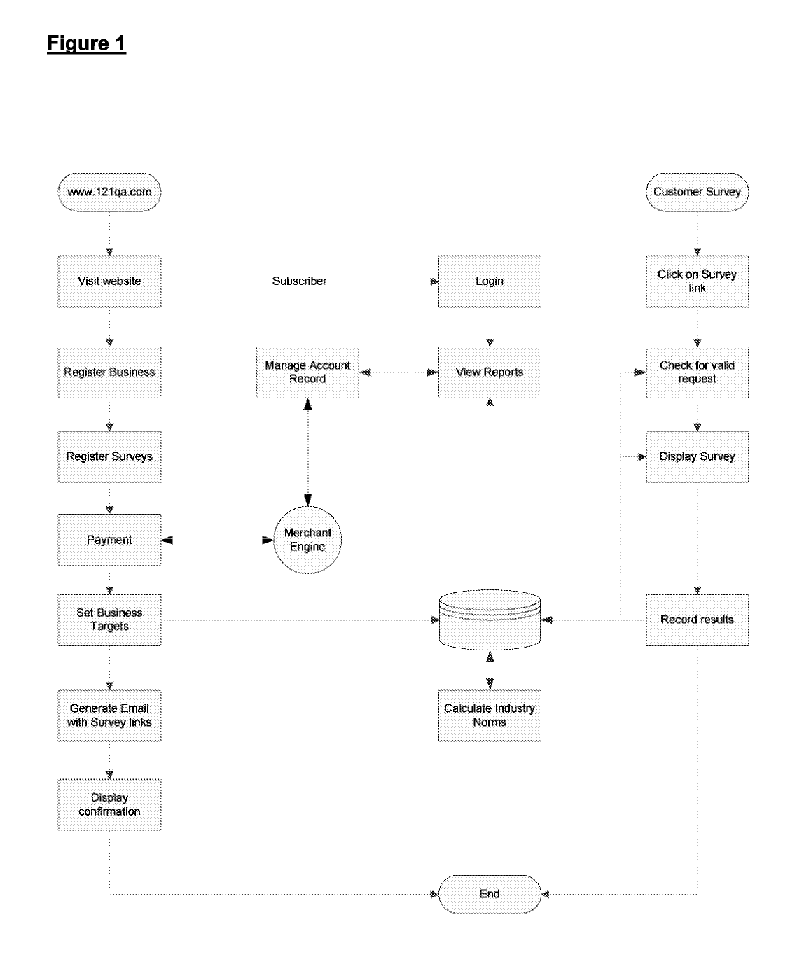

FIG. 1 shows the overall architecture of the 121QA™ system. User organizations gain access over the internet by way of the procedure shown on the left. The organization is registered as a user, and selects surveys it wishes to have run (the industry as a whole, industry subdivisions, different service providers, and so on). Payment is a monthly $10.00 fee for each survey currently under way, plus a single $49.95 system access fee, which sets up a survey database partition and reporting protocol (collectively referred to as the survey engine). Upon payment (for example, through a credit card charging system such as Beanstream™), the system provides the user with survey links. These links are used to set up an input terminal at the site of each user organization for immediate input of survey data by customers at the time of service.

Consumers of the service are given an opportunity to respond to the survey at the place of business. All customers can be given access, or someone at the organization (such as the service provider or receptionist) may elect particular customers to take the survey so as to obtain data from customers fitting a particular profile. The data is then stored on the survey database and compiled. When a user organization next goes to the system's URL on the left, they log in using their password and have access to survey reports and diagnostics.

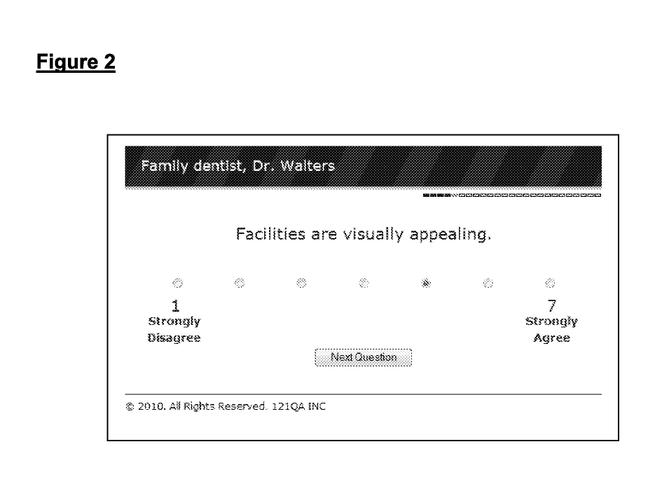

FIG. 2 shows how customers are surveyed through an input portal. The customers score each question on a 7 point Likert scale. Questions are answered in sequence to progress by clicking the appropriate radio button. The system can be set up so that answers can not be changed and comments are left on the system when all questions are scored.

There are 25 questions: 3 measures of Customer Loyalty—satisfaction, repurchase and referral, and 22 perceptual measures of service quality, based on the American Standard SERVQUAL/SERVPERF. For SERVQUAL see Zeithaml, Parasuraman & Berry, “Delivering Quality Service; Balancing Customer Perceptions and Expectations,” Free Press, 1990; and Nyeck, S., Morales, M., Ladhari, R., & Pons, F. (2002). “10 years of service quality measurement: reviewing the use of the SERVQUAL instrument.” Cuadernos de Difusion, 7(13), 101-107. For SERVPERF see Fogarty, G., Cafts, R., & Forlin, C. (2000). Identifying shortcomings in the measurement of service quality. Journal of Outcome Measurement, 4(1), 425-447.

If a customer wishes to provide more detailed written comments, the system provides a secure link is sent to the e-mail address they specify. They input their comments by way of the link from their home computer. Once comments are posted, the link is disabled.

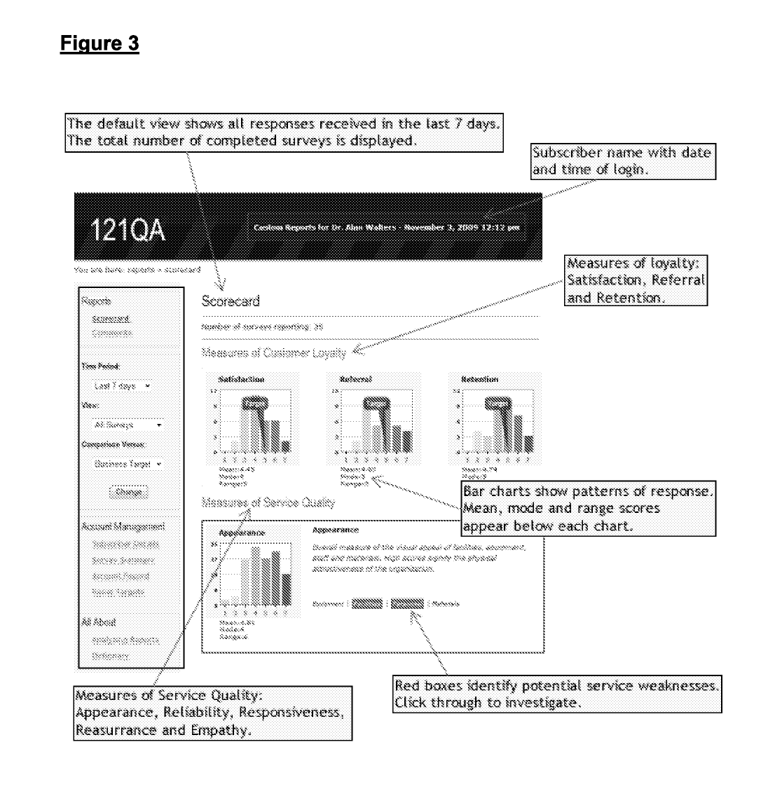

FIG. 3 shows a sample scorecard report obtained from 121QA™. When problems exist, areas of concern light up, and investigations can be made by clicking through the link. The scorecard serves two functions: it displays all survey gathered intelligence, and it simplifies the process of investigating remedies.

On the right side are a series of bar charts. This is where survey scores are graphed, statistics are displayed and benchmarks are flagged. Charts exist for each survey question and are organized into six groupings. The first group across the top includes the 3 measures of service quality. Below the 22 measures of service quality appear organized into the 5 dimensions—appearance, reliability, responsiveness, reassurance and empathy.

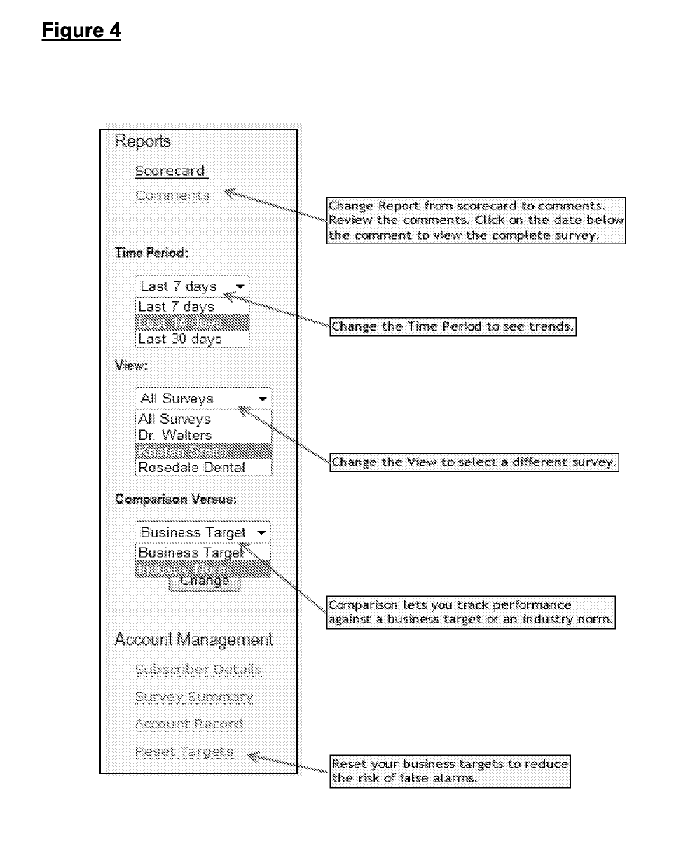

FIG. 4 shows a detail of the navigation control panel on the left of the screen. There are three viewing options: time period (sets a date range), view (selects the survey subject) and benchmark (targets or norms). Setting a date range determines the absolute number of surveys contained in a statistical sample. The start and end dates identify the surveys to be included and the auto default is the last 7 days. Extending this time period increases the number of surveys in the analysis. Once submitted the database automatically calculates mean, mode and range values and graphs the survey scores.

Changing the view setting shrinks the scope of analysis or number of surveys in the statistical sample. The auto default is “All Surveys”. This can be changed by the user to view each survey subject and gauge differences in performance across locations, services or staff members. When the survey view is submitted new scores and statistics are automatically calculated and graphed.

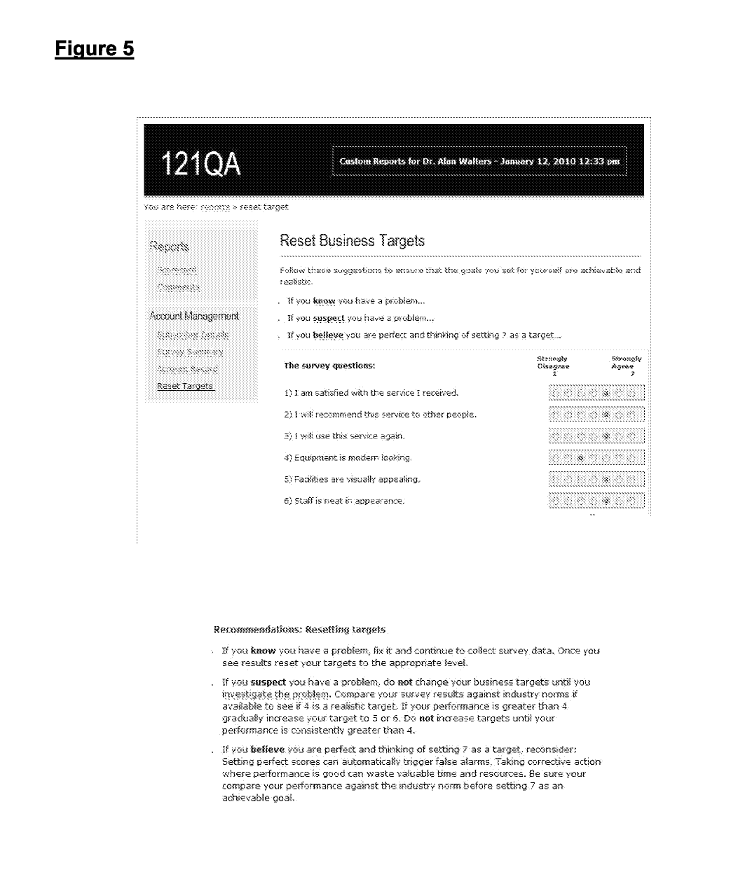

Selecting a benchmark automatically sets the point of comparison against which the survey sample is measured. In the case of the industry norm the comparison is all surveys versus the NAICS or industry. In the case of individual surveys these are compared against the business target. Business targets are set or reset as shown in FIG. 5.

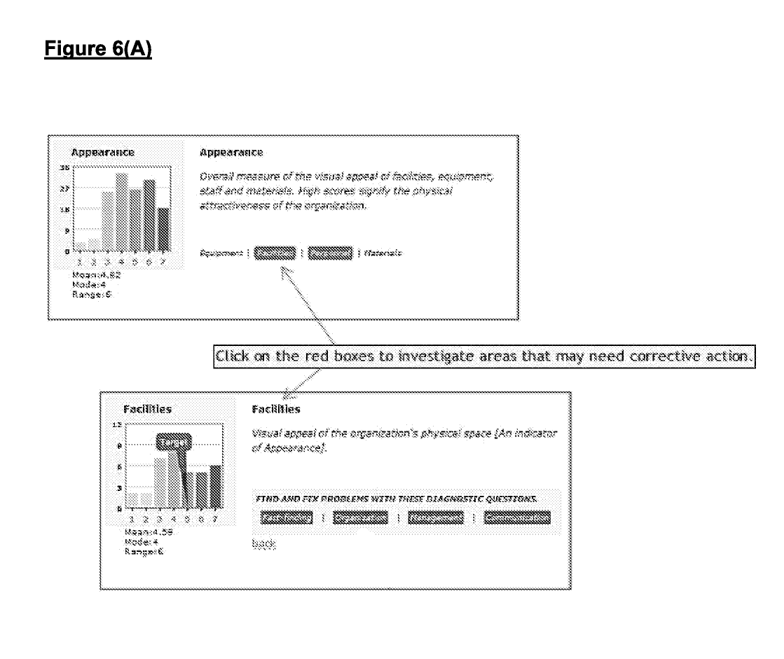

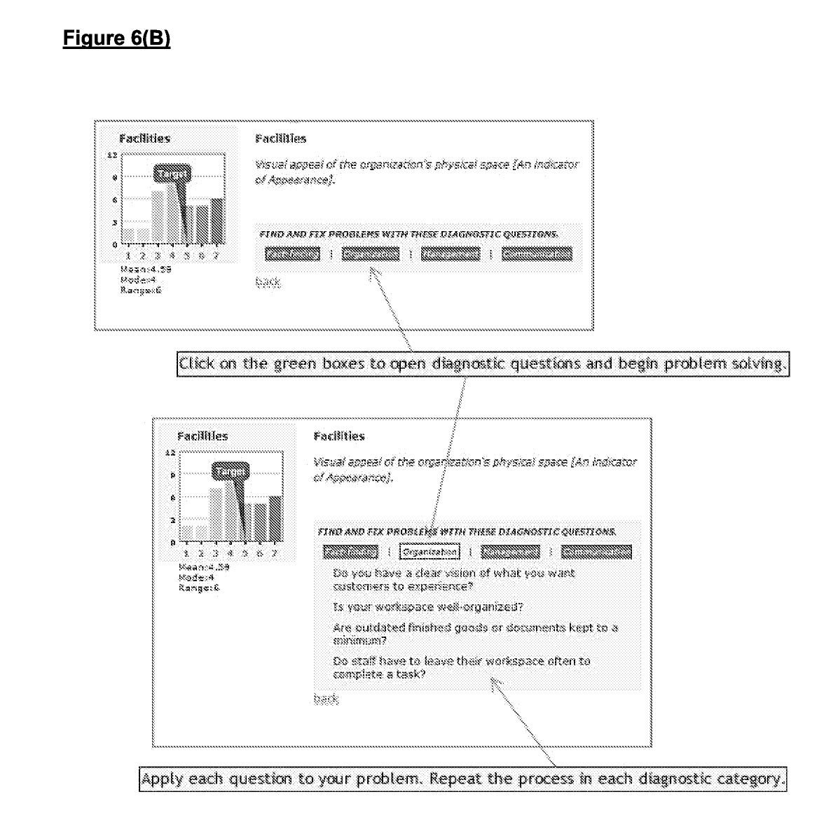

Comparisons serve to isolate areas of deficiency. When the survey sample statistics are equal to or less than the benchmark effected questions or dimensions of service quality are highlighted in red. The red highlights indicate areas that need further investigation (FIG. 6(A)) and the four remedial categories (fact finding, organization, management and communication) automatically appear in green (FIG. 6(B)). To view the diagnostics questions the user simply clicks on the category of interest.

Users can also access customer comments for clues to a problem. Comments can be viewed by changing from the scorecard to the comments report. Comments for the specified date range are displayed in date order. To view a survey, to put the comments in context, the user clicks the date stamp.

121QA™ uses the following 2.0 web components and recognized standards.
File transfer protocol: Hypertext Transfer Protocol (HTTP)
Secure file transfer protocol: Hypertext Transfer Protocol (HTTPS) utilizing CURL
Web server software: Apache Enterprise Server (Apache)
Scripting language: PHP5: Hypertext Preprocessor (PHP)
Relational database management system: Open Source MySQL (MYSQL)
Security: Secure Socket Linkage 128 bit (SSL)
PHP encryption: MD5
Optimized browsers: Internet Explorer, Mozilla Firefox and Safari
Measures of service quality: SERVQUAL (1988), SERVPERF (1994)

In alternative or extended embodiments of the invention, user organizations may be given the option to tailor or customize the survey to remove one or more of the standard metrics, and/or add one or more additional questions or metrics especially chosen because of the nature of the particular service that is provided, or the business objectives of management. By way of illustration, the survey questions can be designed to assess employee satisfaction or satisfaction with a consumer product rather than a service. Automatic problem-specific direction could be given when deficiencies are triggered by statistical comparisons. The statistics could compare one set of survey questions against another or using the same survey to take pre and post measurements. In both cases gap variances would replace variances from a standard measure. The form and method of providing diagnostic prompts could be upgraded, highly specialized and/or framed as answers rather than questions.

The various examples and illustrations referred to in this disclosure are provided for the benefit of the reader, and are not intended to limit the implementation or practice of the invention except where explicitly referred to in the claims that follow. The devices and methods of this invention can be effectively refined or modified by routine optimization without departing from the spirit of the invention embodied in the claims.

The invention claimed is:

1. An apparatus for collecting, analyzing and reporting customer satisfaction data with respect to commercial services provided to customers by several different user organizations, comprising the following components:
a) an input means for receiving scaled scores for a plurality of customer loyalty metrics and a plurality of service quality metrics;
b) a first database storage system, comprising scaled scores on metrics obtained from at least 10 different customers who have purchased or used one or more commercial services provided by each user organization;
c) a first analytical means for compiling the aforesaid scores amongst customers of each commercial service provided by each user organization;
d) a second analytical means for identifying potential errors in each user organization or the way it provides each commercial service, wherein the potential errors are identified using scores compiled by the first analytical means;
e) a second database storage system, comprising questions or further information to address errors leading to suboptimal service quality, customer retention, or customer loyalty that may be selected for each service for each user organization in view of the potential errors identified for that service by the second analytical means; and
f) separate written reports for each commercial service analyzed for each user organization by the apparatus, wherein each report contains the scores compiled by the first analytical means, potential errors identified by the second analytical means, and questions or further information related to the potential errors.

2. The apparatus of claim 1, which further comprises a dedicated terminal at the site of one or more user organizations for immediate input of survey data by customers at or around the time of service.

3. The apparatus of claim 1, which further comprises a database of industry norms for said metrics with respect to said commercial service, and the written report further comprises a comparison of scores compiled for said organization with the industry norms.

4. The apparatus of claim 3, wherein the industry norms are calculated by the apparatus from survey data in the first database obtained from other user organizations in the same industry.

5. The apparatus of claim 1, which further comprises a database of benchmarks or targets for said metrics in said organization, and the written report further comprises a comparison of scores compiled for said organization with the benchmarks or targets.

6. The apparatus of claim 1, wherein:
i) the data in the first database comprises scaled scores on the aforesaid metrics obtained from customers of one or more user organizations that have used the service over a plurality of different time periods;
ii) the apparatus further comprises an analytical means for comparing scaled scores amongst said different time periods; and
iii) the written report for said user organization further comprises an indication of whether the commercial service or service quality has improved since a previous time period.

7. The apparatus of claim 1, wherein:
i) the data in the first database comprises scaled scores on the aforesaid metrics obtained from customers of one or more user organizations that received said commercial service from different individuals at said organization;
ii) the apparatus further comprises an analytical means for comparing scaled scores amongst the different individuals; and
iii) the written report for said user organization comprises a comparison of commercial service or service quality between the different individuals.

8. The apparatus of claim 1, wherein:
i) the data in the first database comprises scaled scores on the aforesaid metrics obtained from customers of one or more user organizations using different divisions or locations of said organization;
ii) the apparatus further comprises an analytical means for comparing scaled scores amongst the different divisions or locations; and
iii) the written report for said user organization further comprises a comparison of commercial service or service quality between the different divisions or locations.

9. The apparatus of claim 1, wherein the customer loyalty metrics are selected from customer reported satisfaction, retention, and referral.

10. The apparatus of claim 1, wherein the service quality metrics are selected from appearance (equipment, facilities, personnel, and/or materials); reliability (promises, problem solving, precision, timeliness, and/or accuracy); responsiveness (full disclosure, promptness, sensitivity, and/or accessibility); reassurance (trust, security, courtesy, and/or knowledge); and empathy (personalization, convenience, attentiveness, consideration, and/or understanding).

11. The apparatus of claim 1, wherein the service quality metrics may be modified by user organizations to deselect certain metrics and/or add others.

12. The apparatus of claim 1, wherein the second analytical means identifies potential errors in different user organization or the way it provides the commercial service by comparing scores compiled for said organization with industry norms.

13. The apparatus of claim 1, wherein the second analytical means identifies potential errors in different user organization or the way it provides the commercial service by comparing scores compiled for said organization with benchmarks or targets set for the commercial service by or on behalf of the organization.

14. The apparatus of claim 1, further comprising a database storage system for customer comments, wherein said comments can be accessed in reference to one or more low scores in said metrics obtained from each customer.

15. A method for evaluating a commercial service provided by an organization, comprising collecting and analyzing customer satisfaction data with respect to said commercial service provided by said organization using the apparatus of claim 1.

16. A method for improving a commercial service provided by an organization, comprising evaluating the commercial service according to claim 15, and then addressing any errors in the organization or the way it provides the commercial service that are identified by the second analytical means.

17. A method for collecting, analyzing and reporting customer satisfaction data with respect to commercial services provided to customers by several different user organizations, comprising:
a) receiving scaled scores for a plurality of customer loyalty metrics and a plurality of service quality metrics for each service from an input terminal located at a place where said service is provided;
b) transmitting the scaled scores from where they are received to a storage database;
c) compiling scores from the database obtained from at least 10 different customers who have purchased or used one or more commercial services provided by each user organization;
d) identifying potential errors in each user organization or the way it provides each commercial service by comparing the compiled scores with target values or industry norms;
e) selecting questions or information from a database to address errors leading to suboptimal service quality in view of the potential errors identified for that service in step d); and
f) preparing written reports for each commercial service comprising the scores compiled in step c) for each commercial service prepared for each user organization, the potential errors identified in step d), and the questions selected in step e).

18. A method for determining industry norms for service quality with respect to commercial services provided to customers by several different user organizations, comprising:
a) receiving scaled scores for a plurality of customer loyalty metrics and a plurality of service quality metrics for each service from an input terminal located at a place where said service is provided;
b) transmitting the scaled scores from where they are received to a storage database;
c) compiling scores periodically from the database from at least 10 different customers who have purchased or used one or more commercial services provided by a plurality of user organizations segregated according to industry or occupational classification, thereby determining norms for said industry or occupation.
d) storing the compiled scores according to industry or occupational classification; and
e) preparing a written report comprising norms for a particular industry or occupation upon request.

19. A method for evaluating customer satisfaction data with respect to a particular commercial service provided to customers by a particular user organization; comprising:
a) collecting customer satisfaction data with respect to the particular commercial service according to claim 17;
b) selecting industry norms determined according to claim 18 according to the industry or occupational classification of the particular commercial service;
c) preparing a written report comprising scores compiled from the data in step a) and norms selected according to step b).

20. The method of claim 17, wherein scaled scores are received for between 15 and 30 standard survey questions provided to each customer for each service for each user organization.
